(19) United States
(12) Patent Application Publication
(10) Pub. No.: US 2021/0123593 A1
(43) Pub. Date: Apr. 29, 2021

(54) OVERHEAD PROJECTOR LIGHTING

(71) Applicant: Rankiri Tissa Karunasiri, Valencia, CA (US)

(72) Inventor: Rankiri Tissa Karunasiri, Valencia, CA (US)

(21) Appl. No.: 16/662,164

(22) Filed: Oct. 24, 2019

(51) Int. Cl. F21V 33/00; G03B 21/14; F21V 23/00

(52) U.S. Cl. CPC F21V 33/0004; F21Y 2115/10; F21V 23/003; G03B 21/145

(57) ABSTRACT

An overhead projector system is described. The overhead projector system may include a projector configured to be coupled to a ceiling or a wall and having a main light source for projecting images and control electronics configured to control the projector. The overhead projector system may also include a power source coupled to the projector and configured to provide power to the main light source. Further, the overhead projector may include an additional lighting source other than the projector light configured to provide light to the room.

### BACKGROUND

Overhead projectors are used in many places ranging from home theaters, conference rooms, classrooms and more. As an audience watches a presentation or a video cast by the projector, optimal viewing of the screen requires darkness in the room. In many cases, it is desired to have some room light available so that audience members can see to do other activities, for example write notes or use an electronic device, etc. This room lighting often obscures optimal viewing of the images being displayed on the screen. Accordingly, there is a need for a system which provides optimal room lighting for an audience while not causing significant degradation of viewing quality of images from an overhead projector.

### SUMMARY

An exemplary embodiment relates to an overhead projector system. The overhead projector system may include a projector configured to be coupled to a ceiling or a wall and having a main light source for projecting images and control electronics configured to control the projector. The overhead projector system may also include a power source coupled to the projector and configured to provide power to the main light source. Further, the overhead projector may include an additional lighting source other than the projector light configured to provide light to the room.

Another exemplary embodiment relates to a lighting source that can be mounted on a projector. The lighting source may include a light source body and an attachment mechanism configured to couple the lights source body to a projector that is configured to be coupled to a ceiling or a wall and has a main light source for projecting images. The lighting source may also include at least one light coupled to the light source body. The lighting source may further include control electronics configured to control the at least one light and a power source coupled to the projector and configured to provide power to the at least one light source.

Yet another exemplary embodiment relates to an overhead projector. The overhead projector may include an additional lighting source other than the projector light use for projecting to the screen, the additional light source being configured to provide ambient lighting to persons in the room while using the projector.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an exemplary embodiment of an overhead projector with a supplemental light fixture.

### DETAILED DESCRIPTION

Overhead projectors have been part of the presentation world for more than a half a century. They are used in professional settings like offices and classrooms throughout the world on a daily basis. In addition, during the last few decades home theaters, using overhead projectors, became very popular. Projectors are popular because they are cost effective and can be installed easily. In addition, projectors provide a very large display for presenting from a computer or a video player. Although larger and larger flat screen TVs have become available in recent times the low-cost projector option will continue to dominate the market place.

These overhead projectors can be setup in a room with minimal improvement. They need a power source and a wall or screen to project the scenes. Often times the projector is mounted overhead on the ceiling and projected onto the wall. A typical room may have original lighting that is designed for normal room illumination. This type of arrangement may interfere with the projected scene due to the illumination of the projection screen by the room lighting. Projectors need a dark room to produce darker scenes on the screen. The displayed content loses contrast if the projection screen is illuminated externally. Therefore, being able to darken the room is important in the projector space. One way to darken a typical room is to close the window coverings and turning off the room lights.

The darkened room is good for the projector image but is not suitable for note taking or reading other material during the presentation. Some of the presentation rooms in work places and classrooms are not designed professionally to accommodate these lighting needs by the projectors and the audience. Similar situations may be encountered in home theater applications as well. It is also seen that people watching a movie in a home theater often like to have relatively dim lighting in the ambience, if that doesn't interfere with the movie, so that they may easily navigate obstacles in the room, read, or see what they are eating, e.g.

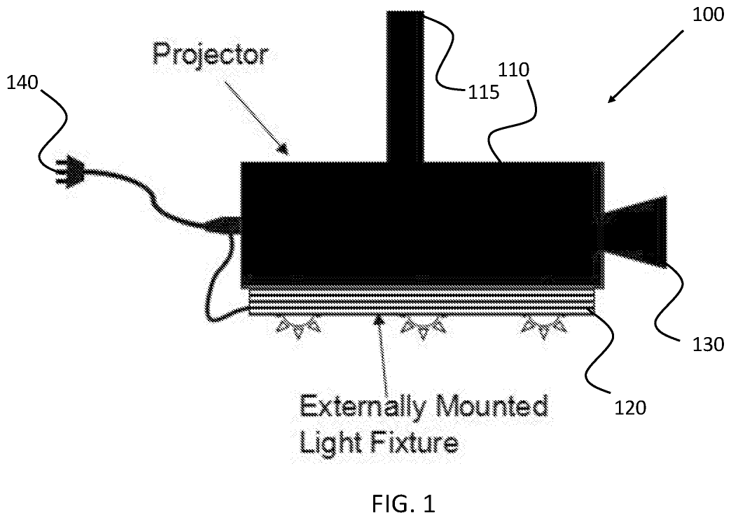

Referring now to FIG. 1, a projection system 100 includes a projector 110 and an externally mounted light fixture 120 coupled to projector 110. Projector 110 has a ceiling mount 115, a projection lens 130 through which the projection light emanates, and a power cord 140 which may provide power to projector 110, externally mounted light fixture 120 or both.

In accordance with an exemplary embodiment, externally mounted light fixture 120 is configured with lights on the bottom of the projector or alternatively on the top or sides of the projector. Generally, exemplary embodiments provide lights on the projector itself. In some embodiments the remote control of the projector may be used as a means to control them in other embodiments light fixture 120 may be controlled by its own remote control or over the internet or local area network (LAN) by an app or the like.

In use, the room lights may be kept completely off during projection viewing and the lights of light fixture 120 may be turned on to produce a useable room light that does not substantially degrade the contrast of the projected image.

The lights on fixture 120 may range from one light to an array of focused lights that can project to different locations in the room including the ceiling. The lights could be located both on top and bottom of the projector to accommodate ceiling mounting as well. The lighting configuration could have spotlights, diffused lights or a combination of both. The lighting fixture 120 may be an add-on to a projector or built into the projector. The lights of fixture 120 may be of any variety including but not limited to incandescent, fluorescent, LEDs, laser lights, etc. The lights of fixture 120 may be white lights or color lights or some combination of white and color lights. In an exemplary embodiment, the lights of fixture 120 may be color lights that are controllable both in intensity and hue. In accordance with a particular exemplary embodiment, the lights of fixture 120 may be designed in to the projector with chip on board type LEDs or laser lights where the additional volume usage is minimized. In other exemplary embodiments light fixture 120 may be a retrofit solution to existing projector installations. For a retrofit, it would be desirable to provide therewith a power splitter cord, such as cord 140, that would take power out from the projector power input cord and then lights will be powered from the same power source as the projector. A retrofit light fixture 120 may be mounted on the projector magnetically, with clamps or additional mounting screws. Alternatively, if additional accessible power sockets are available near the projector then those could be used to power the lights. For the retrofit case the remote-control receiver could be built-in to the light itself and controlled via a separate remote control or the projector remote if programmable to accommodate the light or further be connected to WiFi or the like and controlled through a computer or a mobile device app.

In accordance with an exemplary embodiment lights 120 may be lenses that receive redirected light from the main projector light instead of having their own light sources. In one exemplary embodiment, the lenses may be coupled to a fiber optic cable whose end terminates near the main projector. Alternatively, the main projector light provides light through one or more apertures which provide light directly to the classroom or audience through the apertures.

According to exemplary embodiments, light fixture 120 is used to create a better lighting environment for both screen and audience. This is accomplished by embedding lights on the projector itself that are strategically placed on the projector 110. These lights can be white and or color. White light could be used in classrooms and conference rooms where the color lighting could be used in home theater applications. These light intensities and colors could change with the sound in the movie or music to create additional exciting effects or simply change the ambience. Auto dimming of these embedded lights may also be a part of the programmability that could bring a professional touch to a home theater.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. An overhead projector system, comprising:
a projector configured to be coupled to a ceiling or a wall and having a main light source for projecting images;
control electronics configured to control the projector;
a power source coupled to the projector and configured to provide power to the main light source; and
an additional lighting source other than the projector light configured to provide light to the room.

2. The overhead projector of claim 1, wherein the additional light source receives power from the power source.

3. The overhead projector of claim 1, wherein the additional lighting source is controlled by the control electronics.

4. The overhead projector of claim 1, wherein the additional lighting source is configured to project light towards the audience.

5. The overhead projector of claim 1, wherein the additional lighting source is configured to project light towards the ceiling.

6. The overhead projector of claim 1, wherein the additional lighting source comprises at least one of and LED light and a Laser light.

7. The overhead projector of claim 1, wherein the additional lighting source comprises a single light.

8. The overhead projector of claim 1, wherein the additional lighting source comprises at least one white light.

9. The overhead projector of claim 1, wherein the additional lighting source comprises at least one color light.

10. The overhead projector of claim 1, wherein the additional lighting source comprises at least one white light and at least one color light.

11. The overhead projector of claim 1, wherein the additional lighting source comprises light redirected from the main light source.

12. The overhead projector of claim 1, wherein the additional lighting source comprises at least one diffused light.

13. The overhead projector of claim 1, wherein the additional lighting source comprises a mechanism to increase and decrease intensity.

14. The overhead projector of claim 1, wherein the additional lighting source comprises a control circuit to change the lighting intensity and or color depending on an additional electrical signal input.

15. The overhead projector of claim 14, wherein the additional electrical input comprises at least one an audio signal a projector video, a signal from a remote control, a signal from a smart phone.

16. A lighting source that can be mounted on a projector, comprising:
a light source body,
an attachment mechanism configured to couple the lights source body to a projector that is configured to be coupled to a ceiling or a wall and has a main light source for projecting images;
at least one light coupled to the light source body;
control electronics configured to control the at least one light;
a power source coupled to the projector and configured to provide power to the at least one light source.

17. The lighting source of claim 16, wherein the at least one light is configured to project light towards the ceiling.

18. The lighting source of claim 16 wherein the at least one light comprises at least one of a white light and a color light.

19. The lighting source of claim 16, wherein the at least one light comprises a spotlight.

20. An overhead projector comprising:
an additional lighting source other than the projector light used for projecting to the screen, the additional light source being configured to provide ambient lighting to persons in the room while using the projector.
